(19) United States
(12) Patent Application Publication
(10) Pub. No.: US 2020/0047517 A1
(43) Pub. Date: Feb. 13, 2020

(54) PRINTING APPARATUS AND CONTROL METHOD THEREOF

(71) Applicant: CANON KABUSHIKI KAISHA, Tokyo (JP)

(72) Inventor: Shinya Kogure, Yokohama-shi (JP)

(21) Appl. No.: 16/527,213

(22) Filed: Jul. 31, 2019

(30) Foreign Application Priority Data
Aug. 7, 2018 (JP) 2018-148707

(51) Int. Cl. B41J 2/32; B41J 11/00

(52) U.S. Cl. CPC B41J 2/32; B41J 11/002

(57) ABSTRACT

According to the present invention, a printing apparatus is provided which comprises an image forming unit to form an ink image on a transfer member; a heater to heat the ink image on the transfer member; a transfer unit to transfer the ink image on the transfer member to a print medium; a conveyer to convey the print medium; and a controller to control the image forming so as to complete the heating when the print medium conveyed by the conveyer is to be stopped at a predetermined position, stop the conveyance when the heating is completed before the print medium arrives at the predetermined position, and continue the conveyance when the heating is not completed before the print medium arrives at the predetermined position.

### BACKGROUND OF THE INVENTION

### Field of the Invention

The present invention relates to a printing apparatus and a control method thereof, and in particular, for example, a printing apparatus that inspects the quality of an image on a print medium to which the image has been formed and transferred by discharging ink to a transfer member and a control method of the printing apparatus.

### Description of the Related Art

Conventionally, among image forming apparatuses that form an image on a print medium, there is an apparatus that prints an image on a print medium by forming, for example, an image on an intermediate transfer member such as an intermediate drum and transferring the image to the print medium.

In a process in which an image is formed by discharging ink to a transfer member, an image is formed by discharging ink while moving the position of a transfer member that faces an ink discharge unit, and transferring an ink image to a print medium after the resin in the ink image has been melted by heating the ink discharged to the transfer member. However, although the heating temperature during the transfer operation is suitable for heating the transfer member while it is being moved, there is a possibility that the transfer member will become damaged if the heating of the transfer member continues after the movement has stopped.

Hence, for example, in an image forming apparatus disclosed in Japanese Patent Laid-Open No. 2018-12323, when a member applied with a liquid is to be dried while the member is conveyed, the heating is turned on during the conveyance of the member and turned off when the conveyance of the member has stopped. Damage to the apparatus is prevented by turning off an excessive heating operation even during the conveyance operation if the temperature exceeds a threshold.

There is an image forming apparatus in which an inspection unit is installed in a conveyance path and reads an image formed on a print medium for the apparatus to perform an analysis to improve the quality of the formed image. Unless the position where the reading target image is formed on the print medium is stopped at the position facing the inspection unit, the image cannot be correctly read and analyzed. Hence, there is a need to temporarily stop the conveyance of the medium on which the image is formed. Since processes from image forming on a medium to discharging the medium are normally performed in series on a single conveyance path, stopping the conveyance operation to perform an inspection operation will cause the image forming operation to stop. Also, for example, the image forming apparatus disclosed in Japanese Patent Laid-Open No. 2018-12323 estimates, in advance, the time required for the conveyance operation to stop. The image forming apparatus then calculates the distance by which a medium will be conveyed during the estimated time, and confirms whether an error has occurred in each printed page at a position apart from a sheet discharge unit by the calculated distance. As a result, it prevents an error image from being discharged to the sheet discharge unit in the image forming apparatus. Note that the image forming operation is stopped if an error is detected in Japanese Patent Laid-Open No. 2018-12323.

In this manner, if a process such as an inspection or the like which requires the conveyance operation to be temporarily stopped is performed on the downstream side of the image forming operation, the image forming operation is also stopped together with the stopping of the conveyance operation.

However, in Japanese Patent Laid-Open No. 2018-12323, since the heating operation is changed in accordance with the change in the conveyance operation, there is a possibility that the apparatus will become damaged if it takes time to turn off the heating even when the overheating is stopped in accordance with the conveyance operation being stopped. In addition, even if the conveyance operation is stopped in response to an error detection in the manner of Japanese Patent Laid-Open No. 2018-12323, there is a possibility that the apparatus will become damaged if the cause of the generated error is, for example, an error in which the heating cannot be turned off.

### SUMMARY OF THE INVENTION

The present invention provides a printing apparatus in which damage to the apparatus due to a heating operation in an image forming operation is prevented, and a control method thereof.

The present invention includes the following arrangement.

According to one aspect of the present invention, there is provided a printing apparatus comprising: an image forming unit configured to form an ink image on a transfer member; a heating unit configured to heat the ink image formed on the transfer member; a transfer unit configured to transfer the ink image on the transfer member heated by the heating unit to a print medium; a conveyance unit configured to convey the print medium to which the ink image is transferred; and a control unit configured to perform control so as to complete the heating by the heating unit in a case in which the print medium conveyed by the conveyance unit is to be stopped at a predetermined position, stop the conveyance in a case in which the heating is completed before the print medium arrives at the predetermined position, and continue the conveyance in a case in which the heating is not completed before the print medium arrives at the predetermined position.

According to the present invention, it is possible to prevent damage to the apparatus due to the heating operation in the image forming process.

Further features of the present invention will become apparent from the following description of exemplary embodiments with reference to the attached drawings.

### BRIEF DESCRIPTION OF THE DRAWINGS

FIG. 1 is a schematic view showing a printing system;

FIG. 2 is a perspective view showing a print unit;

FIG. 3 is an explanatory view showing a displacement mode of the print unit in FIG. 2;

FIG. 4 is a block diagram showing a control system of the printing system in FIG. 1;

FIG. 5 is a block diagram showing the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8 is a view showing the outer appearance of the arrangement of an inspection unit shown in FIG. 1;

FIG. 9 is a perspective view showing a state in which a print medium passes an image reading region of the inspection unit;

FIG. 10 is a chart showing a sequence in which an image is formed on the print medium and the quality of the image is inspected; and

FIG. 11 is a view showing an example of print media on which image patterns to be used for quality inspection are formed.

### DESCRIPTION OF THE EMBODIMENTS

Embodiments of the present invention will be described with reference to the accompanying drawings. In each view, arrows X and Y indicate horizontal directions perpendicular to each other. An arrow Z indicates a vertical direction.

<Printing System>

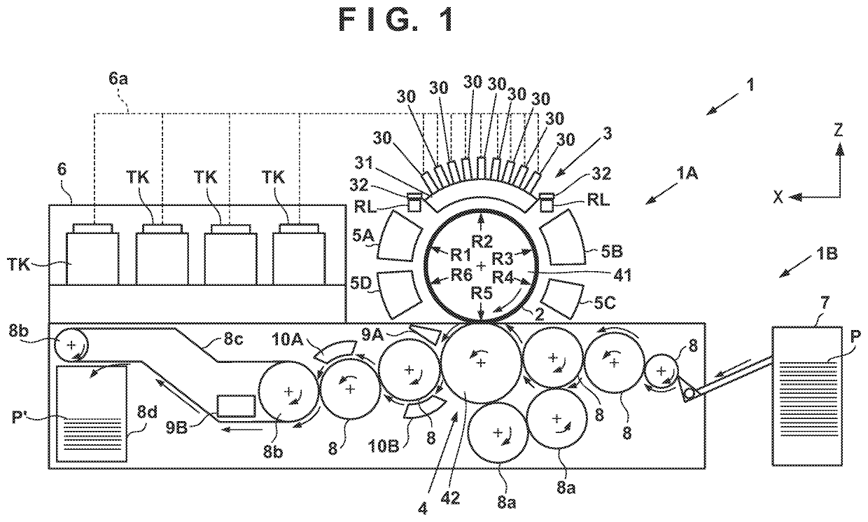

FIG. 1 is a front view schematically showing a printing system 1 according to an embodiment of the present invention. The printing system 1 is a sheet inkjet printer that forms a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

Note that “printing” includes not only formation of significant information such as a character or graphic pattern but also formation of an image, design, or pattern on a print medium in a broader sense or processing of a print medium regardless of whether the information is significant or insignificant or has become obvious to allow human visual perception. In this embodiment, a “print medium” is assumed to be a paper sheet but may be a fabric, plastic film, or the like.

An ink component is not particularly limited. This embodiment, however, assumes a case in which aqueous pigment ink that includes a pigment as a coloring material, water, and a resin is used.

<Printing Apparatus>

The printing apparatus 1A includes a print unit 3, a transfer unit 4, peripheral units 5A to 5D, and a supply unit 6.

<Print Unit>

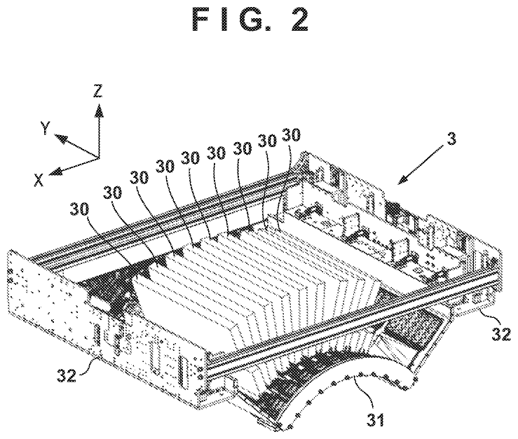

The print unit 3 includes a plurality of printheads 30 and a carriage 31. A description will be made with reference to FIGS. 1 and 2. FIG. 2 is a perspective view showing the print unit 3. The printheads 30 discharge liquid ink to the transfer member 2 and form ink images of a printed image on the transfer member 2.

In this embodiment, each printhead 30 is a full-line head extending in the Y direction, and nozzles are arrayed in a range where they cover the width of an image printing region of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a known inkjet printer is applicable. For example, an element that discharges ink by causing film boiling in ink with an electrothermal transducer and forming a bubble, an element that discharges ink by an electromechanical transducer, an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide member RL. In this embodiment, the guide members RL are rail members extending in the Y direction and provided as a pair separately in the X direction. A slide portion 32 is provided on each side of the carriage 31 in the X direction. The slide portions 32 engage with the guide members RL and slide along the guide members RL in the Y direction.

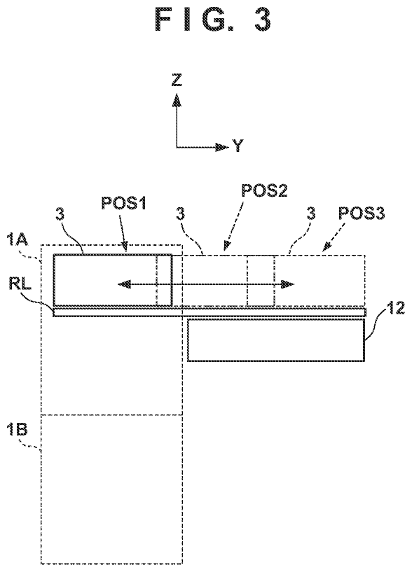

FIG. 3 is a view showing a displacement mode of the print unit 3 and schematically showing the right side surface of the printing system 1. A recovery unit 12 is provided in the rear of the printing system 1. The recovery unit 12 has a mechanism of recovering discharge performance of the printheads 30. For example, a cap mechanism that caps the ink discharge surface of each printhead 30, a wiper mechanism that wipes the ink discharge surface, and a suction mechanism that sucks ink in the printhead 30 by a negative pressure from the ink discharge surface can be given as such mechanisms.

The guide member RL extends over the recovery unit 12 from the side of the transfer member 2. By the guidance of the guide member RL, the print unit 3 can be displaced between a discharge position POS1 at which the print unit 3 is indicated by a solid line and a recovery position POS3 at which the print unit 3 is indicated by a broken line, and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is located above the recovery unit 12. The recovery unit 12 can perform recovery processing on the printheads 30 when the print unit 3 is located at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

<Transfer Unit>

The transfer unit 4 will be described with reference to FIG. 1. The transfer unit 4 includes a transfer drum 41 and a pressurizing drum 42. Each of these drums is a rotating member that rotates about a rotation axis in the Y direction and has a cylindrical outer peripheral surface. In FIG. 1, arrows shown in respective views of the transfer drum 41 and the pressurizing drum 42 indicate their rotation directions. The transfer drum 41 rotates clockwise, and the pressurizing drum 42 rotates anticlockwise.

The transfer drum 41 is a support member that supports the transfer member 2 on its outer peripheral surface. The transfer member 2 is provided on the outer peripheral surface of the transfer drum 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer drum 41.

The transfer member 2 moves cyclically on the circular orbit by rotating the transfer drum 41. By the rotational phase of the transfer drum 41, the position of the transfer member 2 can be discriminated into a processing region R1 before discharge, a discharge region R2, processing regions R3 and R4 after discharge, a transfer region R5, and a processing region R6 after transfer. The transfer member 2 passes through these regions cyclically.

The processing region R1 before discharge is a region where preprocessing is performed on the transfer member 2 before the print unit 3 discharges ink and a region where the peripheral unit 5A performs processing. In this embodiment, a reactive liquid is applied. The discharge region R2 is a formation region where the print unit 3 forms an ink image by discharging ink to the transfer member 2. The processing regions R3 and R4 after discharge are processing regions where processing is performed on the ink image after ink discharge. The processing region R3 after discharge is a region where the peripheral unit 5B performs processing, and the processing region R4 after discharge is a region where the peripheral unit 5C performs processing. The transfer region R5 is a region where the transfer unit 4 transfers the ink image on the transfer member 2 to the print medium P. The processing region R6 after transfer is a region where post processing is performed on the transfer member 2 after transfer and a region where the peripheral unit 5D performs processing.

In this embodiment, the discharge region R2 is a region with a predetermined section. The other regions R1 and R3 to R6 have narrower sections than the discharge region R2. Compared to the face of a clock, in this embodiment, the processing region R1 before discharge is positioned at almost 10 o'clock, the discharge region R2 is in a range from almost 11 o'clock to 1 o'clock, the processing region R3 after discharge is positioned at almost 2 o'clock, and the processing region R4 after discharge is positioned at almost 4 o'clock. The transfer region R5 is positioned at almost 6 o'clock, and the processing region R6 after transfer is a region at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide an arbitrary surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl silicon rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small compression set. They are also advantageous in terms of transferability because of their small elasticity change by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modulus in order to suppress elongation in a horizontal direction or maintain resilience when attached to the transfer drum 41. Woven fabric may be used as a reinforce layer. The transfer member 2 can be manufactured by arbitrarily combining the respective layers formed by the materials described above.

The outer peripheral surface of the pressurizing drum 42 is pressed against the transfer member 2. At least one grip mechanism that grips the leading edge portion of the print medium P is provided on the outer peripheral surface of the pressurizing drum 42. A plurality of grip mechanisms may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42.

The transfer drum 41 and the pressurizing drum 42 share a driving source such as a motor that drives them. A driving force can be delivered by a transmission mechanism such as a gear mechanism.

<Peripheral Units>

The peripheral units 5A to 5D are arranged around the transfer drum 41. In this embodiment, the peripheral units 5A to 5D are an application unit, an absorption unit, a heating unit, and a cleaning unit, respectively, in order.

The application unit 5A is a mechanism that applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism that applies the reactive liquid. If the reactive liquid is applied to the transfer member 2 before the ink is discharged to the transfer member 2, it is possible to immediately fix ink that reaches the transfer member 2. This makes it possible to suppress breeding caused by mixing adjacent inks.

The absorption unit 5B is a mechanism that absorbs a liquid component from the ink image on the transfer member 2 before transfer. It is possible to suppress, for example, a blur of an image printed on the print medium P by decreasing the liquid component of the ink image. Describing a decrease in liquid component from another point of view, it is also possible to represent it as condensing ink that forms the ink image on the transfer member 2. Condensing the ink means increasing the content of a solid content such as a coloring material or a resin contained in the ink with respect to the liquid component by decreasing the liquid component contained in the ink.

The absorption unit 5B includes, for example, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5C is a mechanism that heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5C can use a known heating device, for example, various lamps such as infrared rays, a warm air fan, or the like. An infrared heater can be used in terms of heating efficiency.

The cleaning unit 5D is a mechanism that cleans the transfer member 2 after transfer. The cleaning unit 5D removes ink remaining on the transfer member 2, dust on the transfer member 2, or the like. The peripheral unit 5D can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the absorption unit 5B, the heating unit 5C, and the cleaning unit 5D are included as the peripheral units. However, some of these units may each be provided with the cooling function of the transfer member 2 or added with a cooling unit. In this embodiment, the temperature of the transfer member 2 may rise by heat of the heating unit 5C. If the ink image exceeds the boiling point of water as a prime solvent of ink after the print unit 3 discharges ink to the transfer member 2, performance of liquid component absorption by the absorption unit 5B may degrade. It is possible to maintain the performance of liquid component absorption by cooling the transfer member 2 such that the discharged ink is maintained below the boiling point of water.

The cooling unit may be an air blowing mechanism that blows air to the transfer member 2, or a mechanism that brings a member (for example, a roller) into contact with the transfer member 2 and cools this member by air-cooling or water-cooling. The cooling unit may be a mechanism that cools the cleaning member of the cleaning unit 5D. A cooling timing may be a period before application of the reactive liquid after transfer.

<Supply Unit>

The supply unit 6 is a mechanism that supplies ink to each printhead 30 of the print unit 3. The supply unit 6 may be provided on the rear side of the printing system 1. The supply unit 6 includes a reservoir TK that reserves ink for each kind of ink Each reservoir TK may include a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink A deaerating mechanism that deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is located lower than the ink discharge surface of the printhead 30.

<Conveyance Apparatus>

The conveyance apparatus 1B is an apparatus that feeds the print medium P to the transfer unit 4 and discharges, from the transfer unit 4, the printed product P′ to which the ink image is transferred. The conveyance apparatus 1B includes a feeding unit 7, a plurality of conveyance drums 8 and 8a, two sprockets 8b, a chain 8c, and a collection unit 8d. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism that feeds the print media P one by one from the stacking unit to the most upstream conveyance drum 8. Each of the conveyance drums 8 and 8a is a rotating body that rotates about the rotation axis in the Y direction and has a cylindrical outer peripheral surface. At least one grip mechanism that grips the leading edge portion of the print medium P (or printed product P′) is provided on the outer peripheral surface of each of the conveyance drums 8 and 8a. A gripping operation and release operation of each grip mechanism may be controlled such that the print medium P is transferred between the adjacent conveyance drums.

The two conveyance drums 8a are used to reverse the print medium P. When the print medium P undergoes double-sided printing, it is not transferred to the conveyance drum 8 adjacent on the downstream side but transferred to the conveyance drums 8a from the pressurizing drum 42 after transfer onto the surface. The print medium P is reversed via the two conveyance drums 8a and transferred to the pressurizing drum 42 again via the conveyance drums 8 on the upstream side of the pressurizing drum 42. Consequently, the reverse surface of the print medium P faces the transfer drum 41, transferring the ink image to the reverse surface.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 8 located at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

<Post Processing Unit>

The conveyance apparatus 1B includes post processing units 10A and 10B. The post processing units 10A and 10B are mechanisms that are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. For example, coating performed for the purpose of image protection, gloss, and the like on the image printed surface of the printed product P′ can be given as an example of processing contents. For example, liquid application, sheet welding, lamination, and the like can be given as coating contents.

<Inspection Unit>

The conveyance apparatus 1B includes inspection units 9A and 9B. The inspection units 9A and 9B are mechanisms that are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a change in tint or the like of the printed image due to time and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily stopping the run of the chain 8c, that is, by stopping the conveyance of the printed product P′. The inspection unit 9B may be a scanner that scans the printed product P′.

<Control Unit>

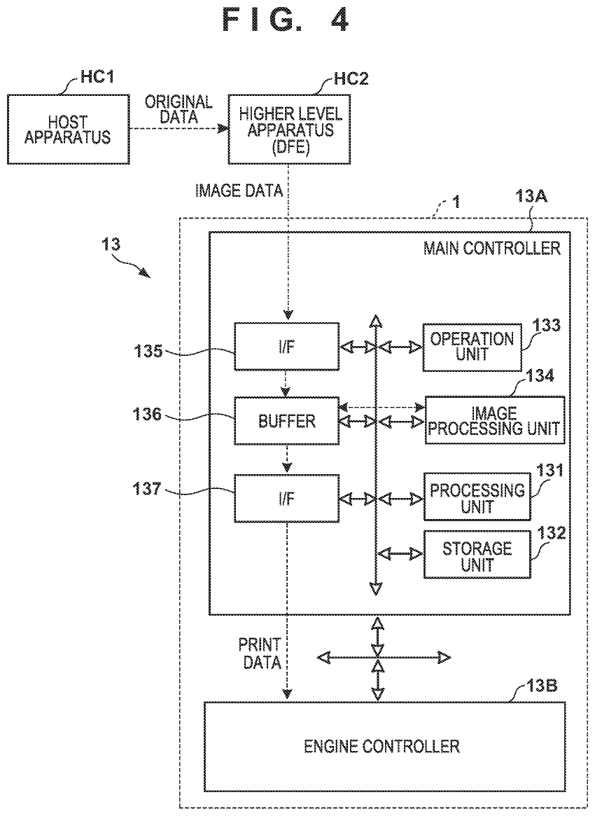

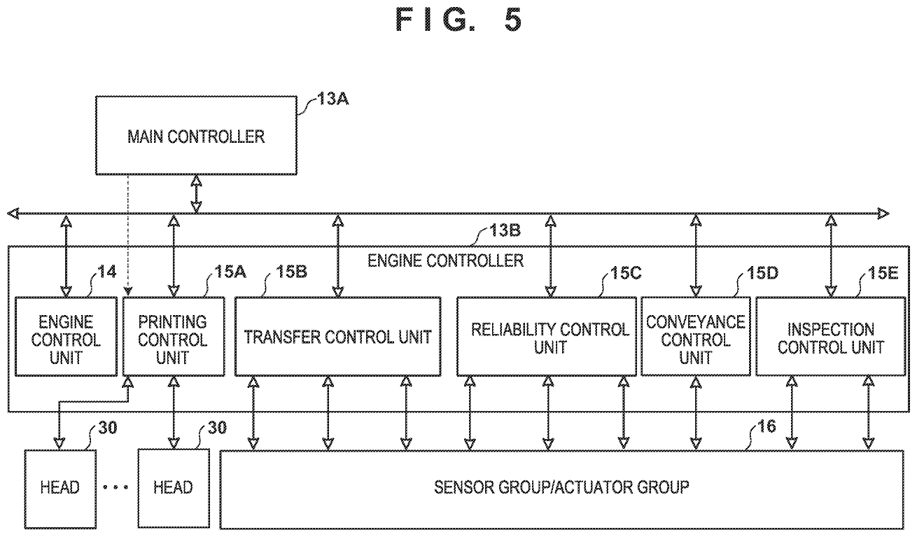

A control unit of the printing system 1 will be described next. FIGS. 4 and 5 are block diagrams each showing a control unit 13 of the printing system 1. The control unit 13 is communicably connected to a higher level apparatus (DFE) HC2, and the higher level apparatus HC2 is communicably connected to a host apparatus HC1.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) usable by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the CPU 131, and provides the CPU 131 with a work area. The operation unit 133 is, for example, an input device such as a touch panel, a keyboard, or a mouse and accepts a user instruction.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes control units 14 and 15A to 15E, and acquires a detection result of a sensor group/actuator group 16 of the printing system 1 and performs driving control. Each of these control units includes a processor such as a CPU, a storage device such as a RAM or a ROM, and an interface with an external device. Note that the division of the control units is an example, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the absorption unit 5B, the heating unit 5C, and the cleaning unit 5D.

The reliability control unit 15C controls the supply unit 6, the recovery unit 12, and a driving mechanism that moves the print unit 3 between the discharge position POS1 and the recovery position POS3.

The conveyance control unit 15D controls driving of the transfer unit 4 and controls the conveyance apparatus 1B. The inspection control unit 15E controls the inspection units 9B and 9A.

Of the sensor group/actuator group 16, the sensor group includes a sensor that detects the position and speed of a movable part, a sensor that detects a temperature, and an image sensor. The actuator group includes a motor, an electromagnetic solenoid, and an electromagnetic valve.

<Operation Example>

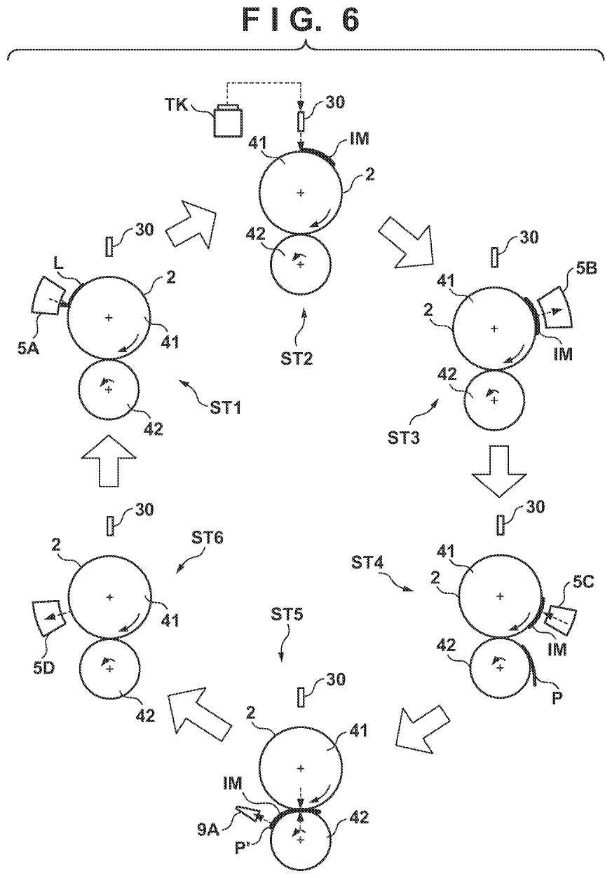

FIG. 6 is a view schematically showing an example of a printing operation. Respective steps below are performed cyclically while rotating the transfer drum 41 and the pressurizing drum 42. As shown in a state ST1, first, a reactive liquid L is applied from the application unit 5A onto the transfer member 2. A portion, on the transfer member 2, to which the reactive liquid L is applied, moves along with the rotation of the transfer drum 41. When the portion to which the reactive liquid L is applied reaches under the printhead 30, ink is discharged from the printhead 30 to the transfer member 2, as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the absorption unit 5B, as shown in a state ST3, the absorption unit 5B absorbs a liquid component from the ink image IM. When the ink image IM reaches the heating unit 5C, as shown in a state ST4, the heating unit 5C heats the ink image IM, a resin in the ink image IM melts, and a film of the ink image IM is formed. In synchronism with such formation of the ink image IM, the conveyance apparatus 1B conveys the print medium P.

As shown in a state ST5, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion, on the transfer member 2, where the ink image IM is formed reaches the cleaning unit 5D, it is cleaned by the cleaning unit 5D, as shown in a state ST6. After the cleaning, the transfer member 2 rotates once, and transfer of the ink image to the print medium P is performed repeatedly in the same procedure. For the sake of descriptive convenience, the description above has been given such that transfer of the ink image IM to one print medium P is performed once in one rotation of the transfer member 2. It is possible, however, to continuously perform transfer of the ink image IM to the plurality of print media P in one rotation of the transfer member 2.

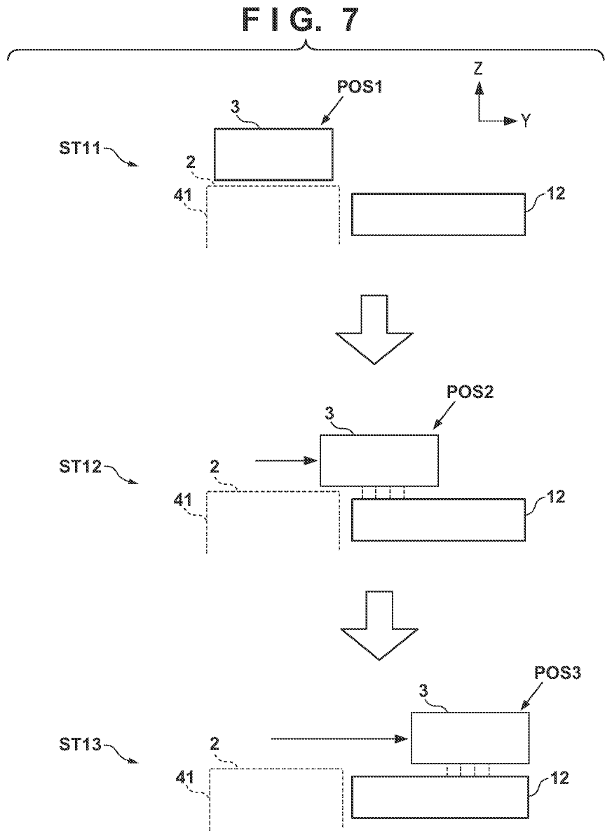

Each printhead 30 needs maintenance if such a printing operation continues. FIG. 7 shows an operation example at the time of maintenance of each printhead 30. A state ST11 shows a state in which the print unit 3 is located at the discharge position POS1. A state ST12 shows a state in which the print unit 3 passes through the preliminary recovery position POS2. Under passage, the recovery unit 12 performs processing of recovering discharge performance of each printhead 30 of the print unit 3. Subsequently, as shown in a state ST13, the recovery unit 12 performs the processing of recovering the discharge performance of each printhead 30 in a state in which the print unit 3 is located at the recovery position POS3.

A method of inspecting the quality of an image formed on a print medium in a printing system having the arrangement described above will be described next. This inspection operation is executed at a time when a printhead is exchanged, at the time of periodic inspection of the printing system, at an arbitrary time set by the user, or the like.

<Detailed Explanation of Inspection Unit 9B>

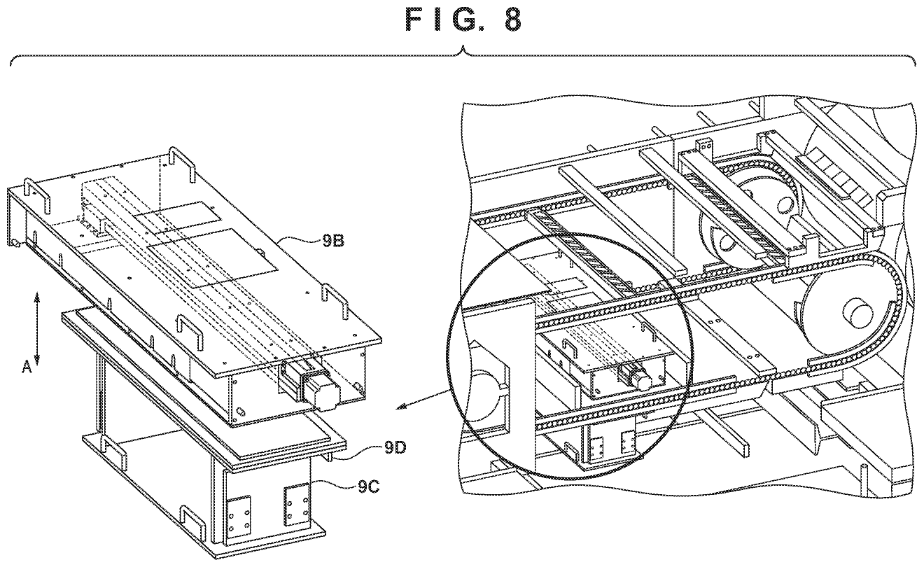

FIG. 8 is a view showing the outer appearance of the arrangement of the inspection unit 9B shown in FIG. 1. A perspective view of a portion where the inspection unit 9B shown in FIG. 1 is arranged is shown on the right hand side of FIG. 8, and an enlarged perspective view of the arrangement of an encircled region in the view on the right hand side is shown on the left hand side of FIG. 8.

The inspection unit 9B according to this embodiment is a scanner that optically reads an image, and a lift-up unit 9C is arranged so as to face the scanner in a state in which the print medium P on the conveyance path is sandwiched between them. In this embodiment, the scanner has a reading width of 850 mm so as to be capable of reading an A0-size print medium in a vertical direction. In addition, the scanner also includes a reading region in which an image can be read at once at an A4-size width (210 mm) in the conveyance direction of the print medium if the print medium is in a still state. Hence, this scanner has a reading region in which an 850 mm (width)×210 mm (length) image can be read at once. An elevating unit 9D, positioned above the lift-up unit 9C, can move in the direction of an arrow A which is a direction perpendicular to the conveyance direction of the print medium P and press the print medium P against the scanner. A white plate provided on the upper surface of the elevating unit 9D has a region of 850 mm (width)×210 mm (length) in correspondence with the size of the reading region of the scanner, and can press the print medium P throughout the entire reading region of the scanner.

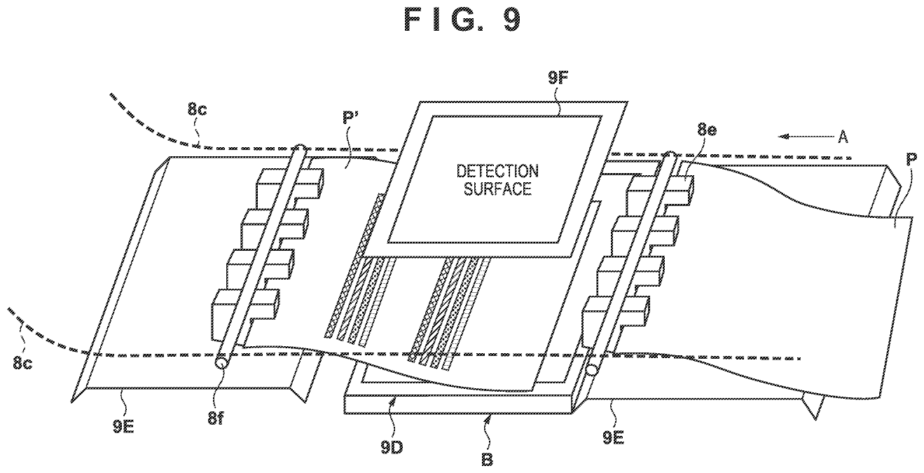

FIG. 9 is a perspective view showing a state in which a print medium passes the image reading region of the inspection unit. The example of FIG. 9 shows a state in which a plurality of the printed products P′ gripped by gripping mechanisms 8e and to which images have been transferred are continuously conveyed in a right-to-left direction as indicated by an arrow A. In this example, the preceding printed product P′ has arrived at a position between a detection surface 9F of the inspection unit 9B and the elevating unit 9D of the lift-up unit 9C, and the succeeding printed product P′ has arrived at a position of a conveyance guide 9E on the right hand side. Each of these gripping mechanisms 8e is fixed to a corresponding chain clipper 8f, and the chain clippers 8f are meshed with the chain 8c. In this manner, the printed products P′ are conveyed in the direction of the arrow A in accordance with the cycle of the chain 8c.

Note that the elevating unit 9D can move in a direction of an arrow B perpendicular to the arrow A. As a result, each printed product P′ that has arrived at a position between the detection surface 9F and the elevating unit 9D can be pressed against the detection surface 9F.

The quality of the image printed by the printing system is inspected by stopping the conveyance of the printed product P′, further pressing and fixing the printed product P′, and causing the scanner to perform reading at a predetermined interval in the conveyance direction of the printed product. The product printed on the print medium is inspected in this manner.

In addition, since the conveyance of the print medium is stopped at an inspection position where the print medium will face the reading region of the inspection unit at the time of the inspection, the image forming operation on each print medium and the inspection of each formed image are performed alternately in this embodiment. Although the image forming operation and the inspection operation performed alternately in this case may be performed, for example, for each print medium, these operations are performed for the maximum sheet count of image-formed and uninspected print media that can be held in the conveyance apparatus 1B in this embodiment. More specifically, the image forming operation and the inspection operation are repeated for the sheet count of print media that can be held between the transfer region R5 and the inspection unit 9B shown in FIG. 1. The specific quantity of the print media is determined depending on the size of each print medium because the distance between the transfer region R5 and the inspection unit 9B is fixed. For example, in this example, if each print medium has a size of B2+, three sheets can be held in the range. Hence, in this example, after the completion of the heating operation of the ink image to be transferred to the last sheet of print media among the three sheets of print media, the image formation operation for a subsequent sheet of print media is temporarily stopped, the held three sheets of print media are sequentially conveyed to the position of the inspection unit 9B, and an inspection operation is performed by reading the image while stopping the conveyance at the position of the inspection unit 9B. A subsequent image forming operation is restarted after the inspection operations of the three sheets of print media have been completed. By separating the image formation phase and the inspection phase in this manner, it is possible to prevent a fault from occurring due to overheating of the transfer drum 41 while the conveyance operation is stopped. Note that, in the following explanation, print media that are to undergo an image forming operation or an inspection operation in a single phase will be called “holdable print media” or “a single unit of print media” or the like, and the sheet count of print media will be called “a holdable sheet count”, “a sheet count per single unit”, “the maximum print sheet count”, or the like.

Sequence of Image Formation and Inspection

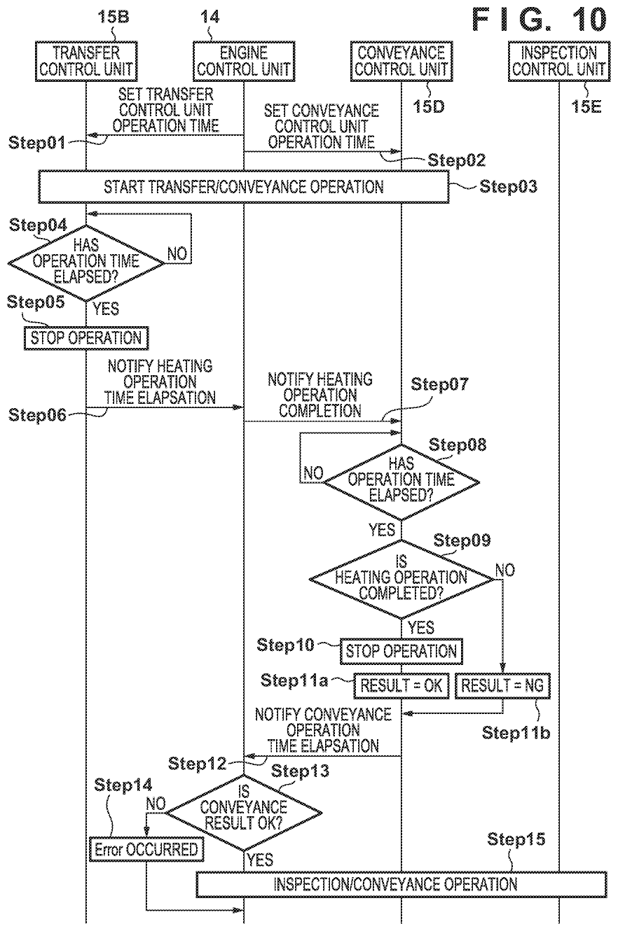

FIG. 10 is a chart showing the sequence for forming images on print media and inspecting the quality of each formed image. The start of the sequence shown in FIG. 10 can be triggered by, for example, detecting the phase of the transfer drum 41 or another roller or detecting the position of a preceding sheet that has arrived at the transfer drum 41 and determining that the detected phase or position has arrived at a predetermined phase or position.

Before the image transfer/conveyance operation for forming an image on each print medium is started, the engine control unit 14 sets the operation time of the transfer control unit to the transfer control unit 15B in Step01, and sets the operation time of the transfer control unit to the conveyance control unit 15D in Step02. The time of each of these operations may be predetermined. The transfer control unit operation time (to be also referred to as transfer time) is, for example, the time from the point of Step03 (to be described later) at which the image transfer operation is started until the trailing edge of the ink image on a transfer member for the final sheet of print media, of the single unit of print media, has passed the heating unit 5C. The conveyance control unit operation time (to be also referred to as conveyance time) is, for example, the time from the point of Step03 (to be described later) at which the image transfer operation is started until the leading edge of the first sheet of the print media, of the single unit of print media, arrives at the inspection unit 9B. At the point in which the conveyance control unit operation time has elapsed, the respective positions where the inspection-target print media are to be present need to be positions between the position of the inspection unit 9B as the leading edge and the transfer region R5 as the trailing edge (that is, until the transfer position). At this point, the image transfer to the trailing edge of the inspection-target print medium must have been completed. Hence, the sheet count of a single unit of print media, that is, the maximum print sheet count is set so that the conveyance control unit operation time will be longer than the transfer control unit operation time.

In this embodiment, the inspection operation can be performed on a maximum of three sheets at once due to the relationship of the length of the conveyance path and the length required for conveying one print medium. If the sheet size is B2+, a maximum of two image patterns, which are to be used in the image quality inspection, can be formed on a single print medium. If the sheet size is small, only one image pattern can be formed on a single medium. If the image patterns required for the analysis of the image quality inspection cannot be contained within three sheets, the image formation operation will be performed over a plurality of operations and the inspection operation will be performed over a plurality of operations.

In Step03, the image transfer/conveyance operation is started by using the conveyance control unit 15D and the transfer control unit 15B including the heating unit 5C.

The transfer control unit 15B waits for the transfer time to elapse in Step04, stops the transfer operation in Step05 when the set time has elapsed (that is, when the heating of the ink images for the single unit of print media have been completed), and shuts down the heat conduction by closing the heat application portion of the heating unit 5C by using a shutter.

When the transfer control unit operation has stopped, the transfer control unit 15B transmits, in Step06, a heating operation time completion notification to the engine control unit 14. Upon receiving this notification, the engine control unit 14 transmits, in Step07, a heating operation completion notification to the conveyance control unit 15D.

The conveyance control unit 15D waits for the conveyance control unit operation time to elapse in Step08 concurrently with Step04, and determines whether it has received the heating operation completion notification in Step09 after the set time has elapsed. If the heating operation completion notification has been received, the conveyance control unit stops the conveyance operation in Step10 and sets the conveyance operation stop result to “OK” in Step11a. On the other hand, the heating operation stop notification processing (Step07) will be delayed if the time of the heating operation stop processing in Step05 is prolonged, if the transmission of the heating operation time completion notification in Step06 is delayed, if the transmission of the heating operation completion notification in Step07 is delayed, or if a plurality of these delays and prolongation occur. If it is determined that the heating operation completion notification has not been received in Step09 due to the delay in the heating operation stop notification processing when the conveyance operation time has elapsed in Step08, the conveyance operation will continue without stopping, and the conveyance operation stop result will be set to “NG” in Step11b.

In Step12, the conveyance control unit 15D transmits the conveyance operation stop result together with the conveyance operation time completion notification to the engine control unit 14. In Step13, the conveyance operation stop result is determined. If the result is “OK”, the inspection/conveyance operation is performed in Step15 by using the conveyance control unit 15D and the inspection control unit 15E. If it is determined that the conveyance operation stop result is “NG” in Step13, “Error” will be generated in Step14, and the inspection/conveyance operation will not be performed. Since the conveyance will not be stopped in this case, the print medium will be stored in the collection unit 8d without undergoing the inspection operation. In addition, since the conveyance will not be stopped in this case, the image forming operation can be immediately restarted.

If it is determined that the conveyance operation stop result is “OK” in Step13, the inspection of the image is performed in Step15. In this case, image reading and inspection of the read image are performed by stopping each sheet of the single unit of print media (alternatively, by stopping each of the plurality of regions of one print medium) at the inspection unit 9B. Since the image forming operation is not performed during the inspection operation, the feeding of print media from, for example, the feeding unit 7 is stopped. Alternatively, if there is a mechanism for timing adjustment before each print medium arrives at the pressurizing drum 42, the print medium may be stopped at the position of this mechanism.

Example of Inspection

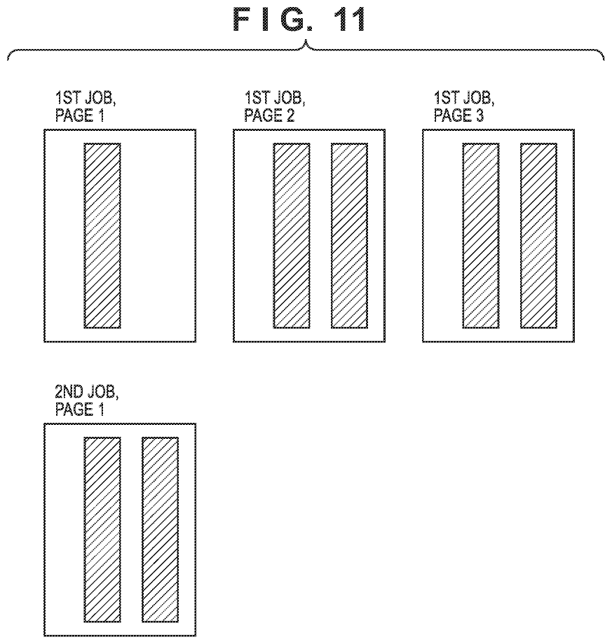

FIG. 11 is an example of the print media on which an image pattern to be used for image quality inspection has been formed. In the inspection/conveyance operation, the reading operation and the conveyance operation are performed alternately for each print medium on which the image pattern is formed in the inspection/conveyance operation. In the case exemplified in FIG. 11, each print medium has a sheet size of B2+, and quality inspection is performed by reading a total of seven image patterns formed on the four sheets of print media. Since only three sheets of print media can be inspected at once, the inspection operation is performed by dividing the print media into two jobs consisting of three sheets and one sheet. That is, the image forming operation and the inspection operation are first performed on the three sheets of print media belonging to the first job, and the image forming operation and the inspection operation are subsequently performed on the one sheet of print medium belonging to the second job. The reading of image patterns is performed sequentially from the left hand side (the downstream side of the conveyance direction of each print medium) in FIG. 11. The reading operation of one image pattern need not be performed only once, but may be performed a plurality of times by switching the reading mode.

One image pattern is formed on the left half of the first page of the first job. The conveyance control unit 15D stops the conveyance operation at a position (that is, a position facing the inspection unit 9B) where the left half region of the page can be read by the inspection control unit 15E. The inspection control unit 15E reads the image pattern formed on the print medium once, and the conveyance control unit 15D restarts the conveyance operation to move the print medium to the next stop position when the reading operation has been completed.

Since the second image pattern is on the left half of the second page of the first job, the next stop position is not the position of the right half of the first page, but the position where the left half of the second page faces the inspection control unit 15E. That is, the reading operation is not performed on the right half region of the first page.

For each of the second and third pages of the first job, the reading operation by the inspection control unit 15E is performed twice at the left half position of each page by switching the reading mode, and each page is conveyed and stopped at the right half position of the page by the conveyance control unit 15D. The reading operation by the inspection control unit 15E is performed twice at the right half position of each page by switching the reading mode, and the conveyance operation by the conveyance control unit 15D is restarted.

After the completion of the reading operation of the right half of the third page belonging to the first job, the conveyance control unit 15D stacks all of the three sheets of print media in the collection unit 8d.

Since the second job only has one page, the reading operation is performed twice on the left half of the page and performed twice on the right half of the page by switching the reading mode each position.

According to the arrangement described above, it is possible to perform control so as to stop the conveyance operation when the heating operation has stopped instead of stopping the heating operation when the conveyance operation has stopped. As a result, it is possible to prevent the printing apparatus, particularly, the transfer drum from overheating.

In addition, the efficiency of the image forming operation can be increased by holding print media, which underwent the image forming operation, based on the maximum sheet count of print media that can be held in the printing apparatus and inspecting the held print media as a whole.

### OTHER EMBODIMENTS

In the above embodiment, the print unit 3 includes the plurality of printheads 30. However, the print unit may include one printhead 30. The printhead 30 need not be a full-line head, but may be of a serial type that forms an ink image by discharging ink from the printhead 30 while scanning a carriage detachably equipped with the printhead 30 in a Y direction.

A conveyance mechanism of a print medium P may adopt another method such as a method of nipping and conveying the print medium P by a pair of rollers. In the method of conveying the print medium P by the pair of rollers or the like, a roll sheet may be used as the print medium P, and a printed product P′ may be formed by cutting the roll sheet after image transfer.

In the above embodiment, the transfer member 2 is provided on the outer peripheral surface of the transfer drum 41. However, another method such as a method of forming a transfer member 2 into an endless swath and running it cyclically may be adopted.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-148707, filed Aug. 7, 2018 which is hereby incorporated by reference herein in its entirety.

What is claimed is:

1. A printing apparatus comprising:
an image forming unit configured to form an ink image on a transfer member;
a heating unit configured to heat the ink image formed on the transfer member;
a transfer unit configured to transfer the ink image on the transfer member heated by the heating unit to a print medium;
a conveyance unit configured to convey the print medium to which the ink image is transferred; and
a control unit configured to perform control so as to complete the heating by the heating unit in a case in which the print medium conveyed by the conveyance unit is to be stopped at a predetermined position, stop the conveyance in a case in which the heating is completed before the print medium arrives at the predetermined position, and continue the conveyance in a case in which the heating is not completed before the print medium arrives at the predetermined position.

2. The apparatus according to claim 1, further comprising:
an inspection unit configured to inspect the ink image transferred to the print medium,
wherein to inspect the ink image by the inspection unit, the control unit stops the conveyance of the print medium at an inspection position where the image transferred to the print medium faces the inspection unit.

3. The apparatus according to claim 2, wherein the conveyance unit includes a conveyance path between the inspection position and a transfer position of the ink image by the transfer unit, and
the control unit causes the heating unit to complete the heating if the heating of the ink image to be transferred to each print medium of the number of print media holdable in the conveyance unit is completed, causes the conveyance unit to stop the conveyance in a case in which the heating is completed before the print medium arrives at the inspection position, and starts an inspection of the ink image transferred to each print medium held in the conveyance path.

4. The apparatus according to claim 2, wherein to inspect the ink image by the inspection unit, the control unit causes the conveyance unit to convey and stop the conveyance of the print medium to the inspection position in accordance with the print medium which is to be an inspection target.

5. The apparatus according to claim 1, wherein the control unit sets, in advance, a time for heating by the heating unit and a time for conveying the print medium by the conveyance unit, and
the control unit determines that the heating has been completed before the print medium has arrived at the predetermined position in a case in which the heating has been completed because the time for heating has elapsed before the time for conveying has elapsed.

6. The apparatus according to claim 1, wherein an image is formed on a surface of the transfer member by cyclically driving the transfer member,
the driving of the transfer member is synchronized with the conveyance of the print medium by the conveyance unit, and the driving of the transfer member is stopped in a case in which the conveyance by the conveyance unit is stopped.

7. The apparatus according to claim 1, wherein the image forming unit forms the ink image by discharging ink onto the transfer member.

8. A control method of a printing apparatus that includes an image forming unit configured to form an ink image on a transfer member, a heating unit configured to heat the ink image formed on the transfer member, a transfer unit configured to transfer the ink image on the transfer member heated by the heating unit to a print medium, and a conveyance unit configured to convey the print medium to which the ink image is transferred, the method comprising:
causing the heating unit to complete the heating in a case in which the print medium conveyed by the conveyance unit is to be stopped at a predetermined position, stopping the conveyance in a case in which the heating is completed before the print medium arrives at the predetermined position, and continuing the conveyance in a case in which the heating is not completed before the print medium arrives at the predetermined position.

9. The method according to claim 8, wherein the printing apparatus further includes an inspection unit configured to inspect the ink image transferred to the print medium, and
the conveyance of the print medium is stopped at an inspection position where the image transferred to the print medium faces the inspection unit to inspect the ink image by the inspection unit.

10. The method according to claim 9, wherein the conveyance unit includes a conveyance path between the inspection position and a transfer position of the ink image by the transfer unit, and
the heating unit completes the heating if the heating of the ink image to be transferred to each print medium of the number of print media holdable in the conveyance unit is completed, the conveyance unit stops the conveyance in a case in which the heating is completed before the print medium arrives at the inspection position, and an inspection of the ink image transferred to each print medium held in the conveyance path is started.

11. The method according to claim 9, wherein to inspect the ink image by the inspection unit, the conveyance unit conveys and stops the conveyance of the print medium to the inspection position in accordance with the print medium which is to be an inspection target.

12. The method according to claim 8, wherein a time for heating by the heating unit and a time for conveying the print medium by the conveyance unit are set in advance, and the heating is determined to have been completed before the print medium has arrived at the predetermined position in a case in which the heating has been completed because the time for heating has elapsed before the time for conveying has elapsed.

13. The method according to claim 8, wherein an image is formed on a surface of the transfer member by cyclically driving the transfer member, the driving of the transfer member is synchronized with the conveyance of the print medium by the conveyance unit, and the driving of the transfer member is stopped in a case in which the conveyance by the conveyance unit is stopped.

14. The method according to claim 8, wherein the image forming unit forms the ink image by discharging ink onto the transfer member.
